(19) United States
(12) Patent Application Publication
(10) Pub. No.: US 2025/0215842 A1
(43) Pub. Date: Jul. 3, 2025

(54) INJECTION DEVICE

(71) Applicant: PHINIA DELPHI LUXEMBOURGE SARL, Belvaux (LU)

(72) Inventor: Nicholas MORE, North London (GB)

(21) Appl. No.: 18/850,551

(22) PCT Filed: Mar. 24, 2023
(86) PCT No.: PCT/EP2023/057742

§ 371 Date: Sep. 24, 2024

(30) Foreign Application Priority Data
Mar. 25, 2022 (GB) 2204251.9

(51) Int. Cl. F02M 21/02; F02M 25/022; F02M 25/03

(52) U.S. Cl. CPC F02M 21/0275; F02M 25/0228; F02M 25/03

(57) ABSTRACT

An injection device for injecting a combined water/gaseous fuel mixture into a combustion space of an engine. The injection device comprises: a first inlet for receiving a supply of water into a water chamber; a second inlet for receiving a supply of gaseous fuel into a flow passage; a mixing device comprising a valve assembly which is configured to control the flow of water between the water chamber and the flow passage so as to establish a combined gaseous fuel/water mixture within the flow passage; and an injection nozzle including a valve needle which is operable to control the delivery of the combined gaseous fuel/water mixture from the flow passage into the combustion space. The disclosure also extends to a fuel injection system.

### FIELD OF THE INVENTION

This invention relates to an injection device for delivering gaseous fuel to a combustion space. In particular, the invention relates to an injection device for delivering gaseous fuel in the form of hydrogen. Aspects of the invention relate to an injection device and a fuel injection system.

### BACKGROUND

In a bid to reduce reliance on fossil fuels, there is a growing trend towards the development of internal combustion engines which are based on hydrogen, or other gaseous fuels. One of the challenges with injecting hydrogen gas is that the high reactivity of hydrogen and the low ignition energy means that it is particularly susceptible to preignition due to hot spots in the combustion chamber.

Water injection is a proven method of reducing preignition, detonation, and NOx in spark ignition engines. However, typically a high water/fuel ratio is required to have a significant effect and has largely limited the commercial application of water injection in mobile applications. The addition of water to the intake charge has two main benefits. Firstly, water has a very high latent heat of vaporisation (2200 kJ/kg). If the energy required to vaporise the liquid water is supplied by the intake charge, then the resultant temperature reduction of the charge reduces the propensity for preignition, detonation, and NOx formation. Secondly, the vaporisation of water reduces the molar fraction of oxygen in the intake charge and thus reduces its reactivity. The water vapour also increases the specific heat capacity of the charge which reduces the propensity for preignition, detonation, and NOx formation.

For spark ignition engines, there are two main types of water injection. Through port injection, water is usually introduced to the intake charge in the manifold/inlet port via an atomising nozzle at low to moderate pressure (less than 10 bar). However, this technique has disadvantages, one of which is that the intake charge is typically too low to effectively evaporate the water, unless the charge:water ratio is very high. This means that the charge cooling potential of the latent heat of vaporization of water is largely wasted. In addition, with port injection, whilst the volume of the liquid water relative to the volume of air is negligible, the partial pressure of its vapour phase can be significant.

Direct water injection provides an alternative method of injecting water into a spark ignition engine, but again this is not without disadvantages. Direct water injection requires less water than port injection due to the greater change in temperature reduction from the latent heat of vaporization which enables less reliance of the diluent effects. However, the challenge of direct water injection is that typically a separate water injector is required. In the confinements of the engine compartment, it is difficult to accommodate a direct water injector in addition to the direct fuel injector, and the spark plug into the cylinder head.

Whilst the principle of water injection is applicable to all fuels, it is especially pertinent to hydrogen fueled engines. However, currently the prior art does not provide a convenient system for allowing injecting of hydrogen gas together with water based on the aforementioned port injection or direct injection techniques known for spark ignition engines.

It is against this background that the invention has been devised.

### SUMMARY OF THE INVENTION

According to a first aspect of the present invention, there is provided an injection device for injecting a combined water/gaseous fuel mixture into a combustion space of an engine, the injection device comprising a first inlet for receiving a supply of water into a water chamber; a second inlet for receiving a supply of gaseous fuel into a flow passage; a mixing device comprising a valve assembly which is configured to control the flow of water between the water chamber and the flow passage so as to establish a combined gaseous fuel/water mixture within the flow passage; and an injection nozzle including a valve needle which is operable to control the delivery of the combined gaseous fuel/water mixture from the flow passage into the combustion space.

The injection nozzle may be an outwardly-opening nozzle in which the valve needle is moved outwards from an injection nozzle housing, towards the combustion chamber, to initiate injection.

In one embodiment, the valve assembly may include an actuator and a shut-off valve member, the actuator being operable to move the shut-off valve member between an open state in which the flow of water is permitted between the water chamber and the flow passage and a closed state in which said flow of water is prevented.

A benefit of this embodiment is that the shut-off valve member is positively activated by means of the actuator (i.e. actively controlled as opposed to passively controlled) which gives rise to good accuracy control of water quantity within the combined gaseous fuel/water mixture and timing of water flow.

In another embodiment, the valve assembly includes a passively controlled shut off valve member. The valve assembly may include a shut-off valve member which is exposed to gaseous fuel within a gaseous fuel chamber and operable to move, depending on the pressure differential across the shut-off valve member, between an open state in which the flow of water is permitted between the water chamber and the flow passage and a closed state in which said flow of water is prevented.

The valve assembly may include a fuel chamber, wherein the pressure of fuel within the fuel chamber acts to close the shut-off valve member.

A venturi device may be provided to create a pressure drop in the flow passage to draw fuel out of the fuel chamber.

The injection device may further comprise at least one suction port in communication with the fuel chamber which also communicates with the flow passage at a position downstream in a throat region of the venturi device.

The shut off valve member may be an annular member and wherein the fuel passage extends through the shut off valve member, forming a compact arrangement.

The mixing device may include a water-metering orifice between the water chamber and the flow passage, whereby the flow of water through the water-metering orifice is under the control of the valve assembly.

The injection device may further comprise a damping chamber for damping movement of the shut off valve member. The damping chamber may be comprised as part of the water chamber or may use fuel as the damping fluid.

In a second aspect of the invention, a fuel injection system for injecting gaseous fuel into a combustion space of an engine, the fuel injection system including a storage assembly comprising a first store for storing gaseous fuel and a second store for storing water, the first and second stores configured to deliver gaseous fuel and water respectively to the injection device of the previous aspect.

The mixing device of the injection device may form a part of the storage assembly.

The injection nozzle and the mixing device may be separated from one another.

The mixing device may be located immediately upstream of the injection device.

The mixing device may be formed in an integrated housing together with the injection device,

The fuel injection system may comprise a plurality of injection devices, each having an associated mixing device and configured to deliver a combined water/fuel mixture from an associated flow passage into the combustion space under the control of the injection nozzle.

In a further aspect of the invention, there is provided a method of operating an injection device for injecting a combined water/gaseous fuel mixture into a combustion space of an engine, the method comprising: receiving a supply of water into a water chamber; receiving a supply of gaseous fuel into a flow passage for fuel; controlling the flow of water between the water chamber and the flow passage by means of a shut-off valve member so as to establish a combined gaseous fuel/water mixture within the flow passage; and operating a valve needle to open so as to inject a combined gaseous fuel/water mixture from the flow passage into the combustion space; further comprising controlling the shut-off valve member to open the flow of water into the flow passage responsive to the opening of the valve needle.

It will be appreciated that preferred and/or optional features of the first or second aspects of the invention may be incorporated alone or in appropriate combination within the other aspect of the invention also.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 is a schematic diagram of a fuel injection system of one aspect of the invention;

FIG. 2 is a schematic diagram of an injection device of a first embodiment for use in the fuel injection system in FIG. 1, with the fuel injector and mixing device in a first state of operation (closed state);

FIG. 3 is a schematic diagram of the injection device in FIG. 2 when in a second state of operation (open state);

FIG. 4 is a schematic diagram of the injection device of a second embodiment for use in the fuel injection system in FIG. 1; with the injection device in a first state of operation (closed state); and

FIG. 5 is a schematic diagram of the injection device in FIG. 4 when in a second state of operation (open state).

In the drawings, as well as in the following description, like features are assigned like reference signs.

### SPECIFIC DESCRIPTION

The present invention relates to a fuel injection system which facilitates injection of a combined mixture of gaseous fuel and water. The invention utilizes a mixing device 30 which mixes a quantity of water with gaseous fuel and an injection device for delivering the combined mixture. For the purpose of this specification, reference to a “combined water/gaseous fuel mixture” shall be taken to mean a combination of water and gaseous fuel in the same flow.

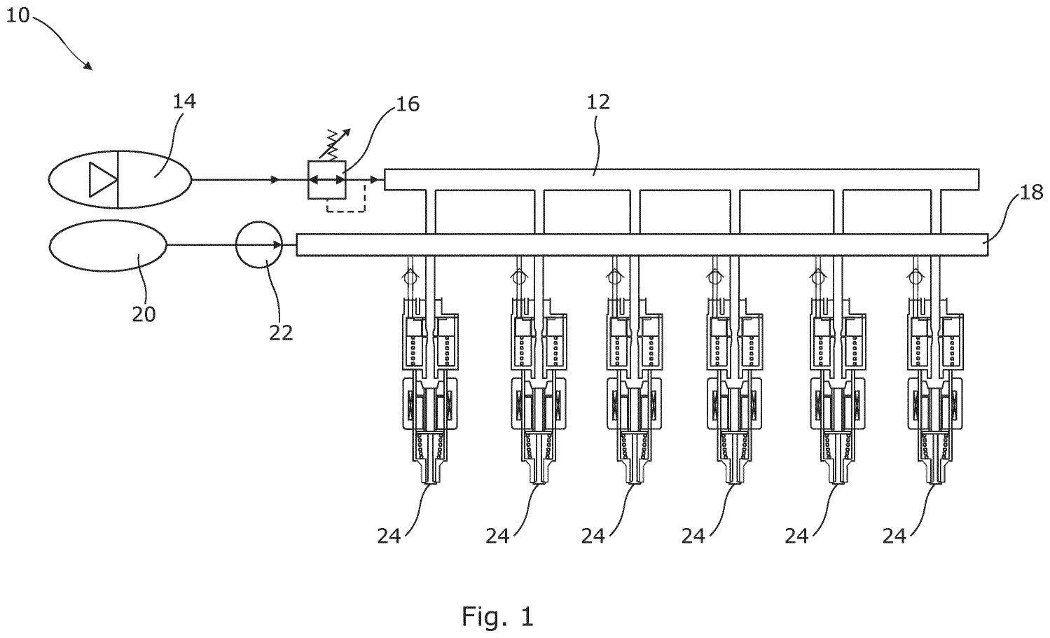

Referring to FIG. 1, a fuel injection system referred to generally as 10 includes an accumulator volume or store 12 in the form of a fuel common rail 12. The fuel is gaseous fuel such as hydrogen, but equally may be another gaseous fuel such as compressed natural gas (CNG). The fuel common rail 12 is supplied with hydrogen from a hydrogen tank 14 which contains gaseous fuel up to a pressure level of around 350 bar. A pressure reducer 16 in the flow line between the hydrogen tank 14 and the fuel common rail 12 reduces pressure to around 40 bar, where it is then stored in the fuel common rail 12 ready for injection.

The system 10 also includes a second accumulator volume for water in the form of a water common rail 18. The water common rail 18 receives water from a water tank 20 through a variable pressure pump 22 which raises the pressure of water supplied by the tank 20 to around 40-45 bar. The water common rail 18 and the fuel common rail 12 are arranged in parallel and are isolated from one another so that the contents of the rails do not mix, until supplied to a mixing device 30, as described in further detail below.

The system shown in FIG. 1 includes a plurality of injection devices, referred to as 24. The water common rail 18 and the fuel common rail 12 deliver water and fuel, respectively, to all injection devices 24 of the system.

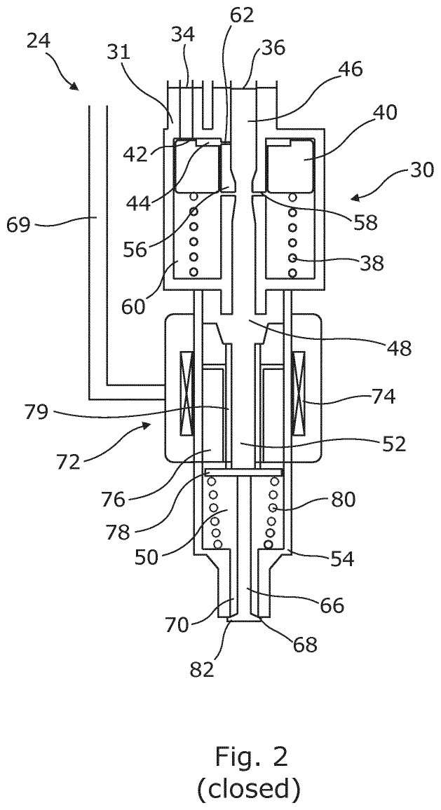

Referring also to FIG. 2, each fuel injection device 24 includes a mixing component in the form of a mixing device 30 and an injecting component in the form of an injection nozzle 32. The mixing device 30 includes a main device housing 31 which defines a fuel chamber 60 having a ceiling 42 and contain a shut-off valve spring 38. The mixing device 30 further includes a first inlet (the water inlet) 34 for receiving water from the water common rail 18 and a second inlet 36 (the fuel inlet) for receiving gaseous fuel from the fuel common rail 12. The water inlet 34 is defined by an orifice that opens into the chamber 60 such that water may be received from the water common rail 18. A shut-off valve member 40 is also housed within the chamber 60 such that the spring 38 serves to urge the shut-off valve member 40 into a closed position (biased in an upward direction in the orientation shown) in which the shut-off valve member 40 seats against the ceiling 42 of the chamber 60. The shut-off valve member 40 is of annular form, defining a central bore (not referenced by number), and is recessed on its upper surface, defining a water chamber 44. When the shut-off valve member 40 moves away from the ceiling 42 of the fuel chamber 60, the water chamber 44 is brought into communication with the water inlet 34 which allows a flow of water into the mixing device 30. When the water inlet 34 is closed and the shut-off valve spring 30 biases the shut-off valve member 40 against ceiling 42, the water inlet 36 is closed. The shut-off valve member 40 may be provided with or constructed from an elastomer on its sealing face. The elastomer has sufficient compliance to seal on multiple seat lines and has good compatibility with water and gases.

A main fuel passage through the device, referred to as the central fuel passage 46, is defined by a channel that extends along a longitudinal axis of the mixing device 30 and through the annular water chamber 44 from the fuel inlet 36 to a fuel outlet 48. The central fuel passage 46 therefore also extends through the annular shut-off valve member 40 providing a particularly compact arrangement. The fuel outlet 48 communicates with a downstream nozzle chamber 50 via a further passage 52 in the injection nozzle 32. The nozzle chamber 50 is defined within an injection nozzle housing in the form of a nozzle body 54 of the injection nozzle 32. The central fuel passage 46 is provided with a restriction or venturi device 56 (also referred to as a venturi throat) part way along its length and a suction port 58 is provided in the wall of the central fuel passage 46 in the region of the venturi throat 56. Two suction ports 58 may be provided (as shown in FIG. 2, where one is numbered), one on either side of the central fuel passage 46, or alternatively an annular suction port 58 may be provided. The suction ports 58 provide a plurality of functions. The suction ports 58 communicate the fuel inlet 35 with the fuel chamber 60 such that, prior to injection, gaseous fuel accumulates within the chamber 60 and is stored at high pressure. The fuel pressure within the chamber 60 therefore provides an additional lift force which urges the shut-off valve member 40 against the ceiling 42 of the chamber 60 and prevents water from flowing into the mixing chamber 30 via the water chamber 44. In addition, the effect of the venturi throat 56 is that, as the gas flows through the fuel inlet 36 towards the fuel outlet 48, a pressure drop is generated within the fuel chamber 60 which causes the fuel to be sucked through the suction port 58 from the fuel chamber 60 into the lower pressure region in the throat 56, hence reducing the pressure beneath the shut-off valve member 40 which determines when the shut-off valve member 40 opens, as discussed further below.

The wall of the central fuel passage 46 is also provided with a water-metering orifice or drilling 62 which provides a communication path with the water inlet 34 via the water chamber 44 and allows water to flow into the central fuel passage 46 from the water chamber 44 when the water-metering orifice 62 is opened. Specifically, the water-metering orifice 62 is open when the shut-off valve member 40 is opened which enables water to flow from the water inlet 34 into the central fuel passage 45.

The shut-off valve spring 38 acts on the shut-off valve member 40 and serves to urge the shut-off valve member 40 upwardly (in the orientation shown) towards the ceiling 42 of the water chamber 44 and into the position in which the water-metering orifice 62 is closed. The pressure of fuel within the fuel chamber 60, together with the spring 30, therefore acts to close the shut-off valve member 40.

As the pressure drops within the fuel chamber 60, the pressure of the water in the water inlet 34 begins to exceed the lift force provided by the combination of the pressure of the fuel in the fuel chamber 60 and the spring force provided by the shut-off valve spring 38, causing the shut-off valve member 40 to move downwardly away from the water inlet 36 and the water-metering orifice 62 is opened. This allows water delivered to the water chamber 44 to flow into the central fuel passage 46 via the water chamber 44, mixing with fuel in the central fuel passage 46.

The nozzle body 54 houses an outwardly-opening valve needle 66 which is operable to engage and disengage from a valve seat 68 to open and close an outlet provided in the nozzle body 54. That is, the injector is on the outwardly-opening type as opposed to the inwardly opening type: in an inwardly-opening fuel injector the valve needle moves inwardly within a bore of the injection nozzle housing to initiate injection, whereas in an outwardly-opening injector the valve needle moves outwardly from the bore of the injection nozzle housing to initiate injection. The valve seat 68 is defined at the end of a bore 70 provided in the nozzle body 54 and the valve needle 66 is opened outwardly from the nozzle body 54 under the control of an actuator arrangement 72, including an electromagnetic solenoid 74 and an armature 76, to move the valve needle 66 towards and away from the valve seat 68. At its upper end, the valve needle 66 is attached to a plate 78 which defines an abutment for a nozzle spring 80. The armature 76 is activated by the actuator arrangement 72 as an electromagnetic force upon application of a current to the solenoid 74. The armature 76 is coupled to a carrier member 79 which is attached to the plate 78. The carrier member 79 defines the further flow passage 52 to the nozzle chamber 54.

The nozzle spring 80 is housed within the nozzle chamber 50 and serves to urge the valve needle 66 into the closed position in which it engages the valve seat 68. When the solenoid 74 is energised, the armature 76 experiences an electromagnetic force which serves to urge the armature 76 and hence the valve needle 66 downwards, opposing the nozzle spring 80 force and causing the valve needle 66 to move away from the valve seat 68.

A return line 69 returns fuel leakage to a source of low pressure fuel in a conventional manner.

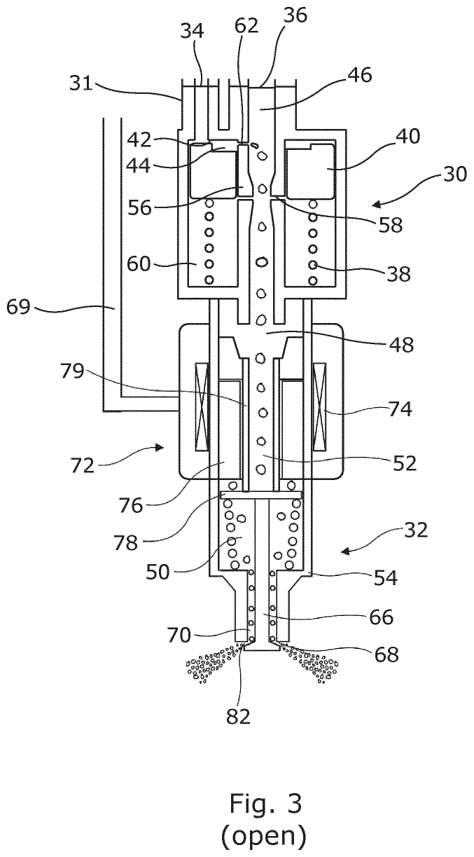

Operation of the injector device 24 and the mixing device 30 will now be further described with reference to FIGS. 2 and 3. Initially, as seen in FIG. 2, the shut-off valve member 40 is closed so that no water can flow into the water chamber 44. The actuator 72 is de-energised and the valve needle 66 is closed. Fuel may be delivered to the fuel inlet 36 but no injection occurs as the valve needle 66 is closed. Subsequently, water is introduced into the water inlet 34 from the water common rail 18 and fuel is introduced into the fuel inlet 36 from the fuel common rail 12. As the fuel flows through the inlet 36 and onwards through the central fuel passage 46, the venturi throat 56 in the central fuel passage 46 results in a pressure drop, causing fuel to be sucked through the suction ports 58 into the central fuel passage 46 for fuel. As pressure within the fuel chamber 60 is reduced, a point is reached at which the forces acting to close the shut-off valve member 40 (the combined force of the shut-off valve spring 38 and pressure within the fuel chamber 60) are overcome by the force acting to open the shut-off valve member 40 due to incoming water at the water inlet 34, thereby causing the shut-off valve member 40 to open. This is the state of the mixing device 30 in FIG. 3 (the open state).

With the shut-off valve member 40 open, water flows into the water chamber 44 and through the water-metering orifice 62 into the central fuel passage 46, thereby mixing with fuel delivered to the central fuel passage 46. In order to inject the fuel/water mixture, the solenoid 74 is activated so as to push the valve needle 66 outwardly from the nozzle body 54, as described previously, opening the fuel outlet 48 into the combustion space. With the valve needle 66 opened, the combined fuel/water mixture can flow through the central fuel passage 46, through the further flow passage 52, through the chamber 50 in the nozzle body 54 and out through a nozzle outlet 82.

To terminate injection, the solenoid 74 is deactivated and the actuation force on the carrier member 79 is relaxed, causing the nozzle spring 80 to urge the valve needle 66 upwardly into engagement with the valve seat 68, into a closed state, in which the nozzle outlet 82 is closed. This is once again the state of the injection nozzle 32 and mixing device 30 shown in FIG. 2.

Because the duty cycle of the injection device is typically low, so that the valve needle 66 is closed for the majority of the engine cycle, it is necessary to ensure that the water-metering orifice 62 is only open for the period of time for which the gas flow is dynamic and fuel is actually being injected. This prevents pooling of the water downstream in the mixing device 30 which is detrimental to performance. One elegance of the embodiment in FIGS. 2 and 3 is that the opening of the valve needle 66 to create the fuel flow into the combustion chamber inherently causes the opening of the shut off valve member 40 which occurs once/when the flow through the central fuel passage 46, upon opening of the valve needle, generates the pressure drop in the fuel chamber 60 via the venturi throat 56. It is important to note that the venturi throat 56 does not suck in fluid but actuates the shut-off valve 40 to synchronize the water metering to the gas injection event. The duration of the gas injection event directly affects the duration (and hence quantity) of the water injection event.

The amount of water that is drawn into the central fuel passage 46 is dependent on the duration of the injection, the size of the water-metering orifice 62, the pressure of the water and the pressure of hydrogen gas. Typically, the water is supplied at a pressure of around 40-45 bar and the hydrogen gas is supplied at a pressure of around 40 bar. Atomisation occurs when the water exits the nozzle outlet 82 into the combustion space. The high velocity of the gaseous fuel exiting the nozzle outlet 82 creates shear which atomises the water droplets.

As mentioned previously, the invention utilises an outwardly opening injector as opposed to an inwardly opening injector. Inherently inwardly-opening injectors can be seen as advantageous because of manufacturing simplicity since the inwardly-opening injector is not subject to back-pressure opening and the subsequent risk of the back-pressure opening the valve needle if that pressure is higher than supply pressure (as can happen in a conventional outwardly-opening injector). This risk can be overcome, however, in the present invention because the water shut-off valve has an inherent non-return function in the event that water pressure is lost. In other words, if the water supply to the inlet 34 is lost, the shut-off member 40 is urged to close the water-metering orifice under the force of the spring 38 and pressure in the chamber 60.

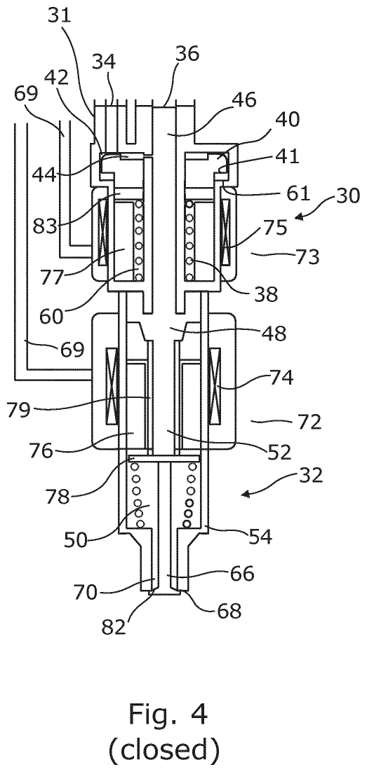

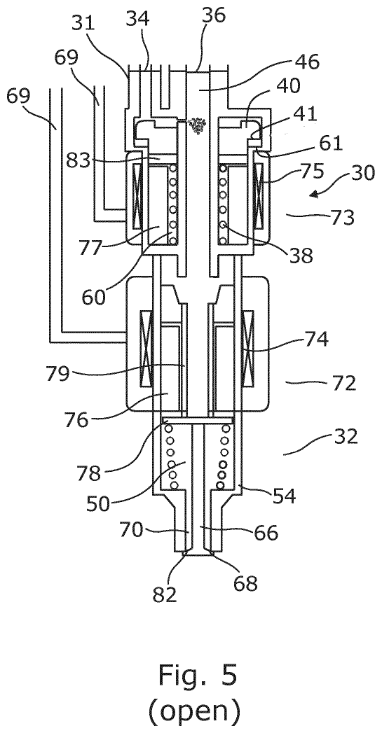

Instead of this ‘passive’ approach to operating the shut-off valve member 40 (as in FIGS. 2 and 3), in an alternative embodiment of the invention, as shown in FIGS. 4 and 5, an actuator arrangement 72 is provided for the shut-off valve member 40 so that it can be actively controlled. The configuration for the fuel chamber 60 and the shut-off valve member 40 is different to that in FIGS. 2 and 3, although similar parts of the fuel injector and the mixing device 30 will be referred to with like reference numerals.

In the embodiment of FIGS. 4 and 5, the mixing device 30 again includes a central fuel passage 46 and a water-metering orifice 62 which provides a communication path between the water inlet 34 and the central fuel passage 46 via the water chamber 44 when the shut-off valve member 40 is open, thereby allowing mixing of water and fuel.

In this particular embodiment, the walls of the fuel chamber 60 have a stepped diameter such that the diameter of the chamber 60 at its upper portion is larger than the diameter of the chamber 60 at its lower portion. In other words, an upper portion of the chamber 60 extends radially outwards from the outer face of the lower portion of the chamber 60 and defines a chamber shoulder portion 61. The mixing device 30 also includes a shut off valve actuator arrangement 73 having a second solenoid 75 which surrounds the lower portion of the fuel chamber 60. For the purpose of the description relating to FIGS. 4 and 5, the first actuator arrangement 72 will be referred to as the injector actuator and the second actuator arrangement 73 will be referred to as the mixer actuator. In this embodiment the fuel chamber 60 is defined radially inward of a pole piece 77. An armature 83 of the mixer actuator 73 resides above the pole piece 77 and is coupled to the shut-off valve member 40 so that, as the solenoid 75 of the mixer actuator 73 is energised, an electromagnetic force is applied to the armature 83 causing it to be drawn downwardly. The armature 83 of the mixer actuator 73 surrounds the central fuel passage 46, and hence the supply of hydrogen fuel, which aids a compact and convenient assembly. In other words, the central fuel passage extends through the armature 83. As a result, the shut-off valve member 40 is caused to move away from the ceiling 42 of the water chamber 44 and the water-metering orifice 62 is opened to open communication between the water chamber 44 and the central fuel passage 46. The central fuel passage 46 in this case does not include a venturi device 56 because the requirement for fuel to be drawn out of the fuel chamber 60 and into the central fuel passage 46, to activate the shut-off valve member 40, is no longer required with the actively controlled valve.

FIG. 4 shows the mixing device 30 and injector 24 with the shut-off valve member 40 closed against the ceiling 42 of the water chamber 42. In this position the shut-off valve member 40 closes the water-metering orifice 62 and there is no mixing of water with fuel in the central fuel passage 46: only fuel is supplied to the central fuel passage 46. If the injector actuator 72 is de-energised at this time (as shown in FIG. 4), the valve needle 66 remains seated against the valve seat 68 and there is no injection of fuel or any other mixture into the combustion space.

In this particular embodiment, the shut-off valve member 40 has a stepped diameter such that the diameter of the shut-off valve member 40 on its upper end or lower portion is larger than the diameter of the shut-off valve member 40 on its lower end or lower portion. In other words, an upper portion of the shut-off valve member 40 extends radially outwards from the outer face of the lower portion of the shut-off valve member 40 and defines a valve shoulder portion 41. When the solenoid 75 is energized and the armature 83 is moved away from the ceiling 42, this causes the valve shoulder portion 41 to engage with the chamber shoulder portion 61 which acts to prevent the armature 83 from moving further in the downward direction.

With reference to FIG. 5, when the solenoid 75 of the mixer actuator 73 is energised, the armature 83 of the mixer actuator 73 is drawn downwardly, drawing the shut-off valve member 40 away from the ceiling of the water chamber 42 and opening the water-metering orifice 62. In this position water delivered through the water inlet 34 can flow into the central fuel passage 46, mixing with fuel delivered through the fuel inlet 36.

If the injector actuator 72 is activated at this time, the armature 78 of the injector actuator 72 is caused to move downwardly, opposing the nozzle spring 80 force, and the valve needle 66 is urged away from the valve seat 68 to allow the fuel/water mixture to be injected into the combustion space.

In this embodiment, the amount of water drawn into the gas flow is dependent on the duration of activation of the solenoid 75 of the mixer actuator 73, the water-metering orifice 62 and the differential pressure between the water and the gas flow. As described previously, typically the water is supplied at a pressure of around 40-45 bar and the hydrogen gas is supplied at a pressure of around 40 bar. Atomisation of water droplets occurs as soon as the nozzle outlet 82 is opened upon activation of the injector actuator 72, and there is minimal atomisation of water inside the nozzle. As before, the shut-off valve 40 operation is timed to ensure that water is only delivered to the fuel flow for the period of time for which the gas flow is dynamic and fuel is actually being injected.

In the embodiment of FIGS. 4 and 5, the shaping of the chamber 60 in the region of the shoulder portion 61 means that the overall diameter of the actuator can be made smaller than the diameter of the shut off valve member 40. The small volume between the valve shoulder portion 41 and the chamber shoulder portion 61 (e.g. for water) may serve to provide a damping function for the shut off valve 40.

One advantage of the embodiment in FIGS. 4 and 5 compared to that in FIGS. 2 and 3 is that the solenoids 74, 75 can be controlled independently, allowing the timing and duration of the water flow to be varied independently of the fuel injection. For example, the water flow through the water inlet 34 may be biased towards the start or end of fuel injection, depending on the operating conditions.

Downstream of the mixing unit 30, water droplets are carried passively in the gas stream into the fuel injector cavity and water and hydrogen are discharged together at the nozzle 54. No mechanical modifications are required to the injection nozzle features which are known for use in injecting only fuel, other than to ensure materials compatibility with water (i.e. corrosion resistance). Austenitic stainless steels are ideal hydrogen injector construction materials since they are both corrosion resistant and resilient to hydrogen embrittlement. However, austenitic steels are not suitable for the magnetic components (e.g. the pole pieces 76 and the armatures 78, 83). The passage of water through the injector 24 must either avoid water contact with these components or these components may be treated with a suitable water-resistant coating.

Water atomization is realized via the differential velocity of water droplets and the gas stream at the outlet 82 of the injection nozzle 32. The water droplets and the hydrogen are subject to the same pressure differential at the nozzle outlet 82. However, because the hydrogen gas is much less dense than liquid water, the gas achieves a much higher injection velocity than the liquid water. This velocity differential creates shear on the water droplets' surface and promotes droplet breakup and atomization. This principle of gas assisted atomization enables superior atomization (smaller droplet size) compared to ‘solid’ water injection for a given injection pressure.

As a modification to the previous embodiments, O-rings may be added to act as rod and piston seals on the inner and outer edge diameters of the shut-off valve member 40. O-rings in these positions can help to reduce any leakage around the shut-off valve member 40. Whilst a small amount of leakage here is not critical to the successful operation of the device, it represents unmetered flow and a sensitivity to clearance tolerances which may be better avoided.

The advantages of the invention are abundant. The upstream, in-line water mixing with gaseous fuel enables co-injection of water and hydrogen gas through a single injection nozzle 32. As a separate dedicated water injector is not required, the system can be configured with relatively low cost. For direct injection applications this reduces packaging requirements in the cylinder head. In addition, the water flow through the injection device will have a cooling effect on the injector components, particularly in the injection nozzle 32 which can reach high temperatures due to exposure to the combustion chamber. The gas assisted atomization of water enables effective atomization of water at moderate pressures (10-40 bar) and this reduces the pump and system requirements compared to solid injection where high pressure (>100 bar) is required. Effective atomization of water maximises the charge cooling potential of water injection via the latent heat of vaporization of water. In particular, for direct injection applications, injecting water during the compression stroke significantly increases the potential for charge cooling before reaching the water saturation pressure of the charge. This enables higher compression ratios and specific outputs to be used whilst avoiding abnormal combustion. Effectively utilizing the latent heat of vaporization to cool the charge reduces the water consumption requirements compared to conventional low pressure port water injection. This reduces vehicle on-board water storage requirements and operating cost. Finally, gas assisted water atomization uses a much larger nozzle orifice than a high-pressure solid-state atomising nozzle. This reduces sensitivity to deposit formation and reduces the cleanliness requirements of the water. This improves tolerance to undistilled water e.g. from recovered exhaust gas condensate or mains water supply and will increase user flexibility and reduce operating cost.

It will be appreciated by a person skilled in the art that the invention could be modified to take many alternative forms to that described herein, without departing from the scope of the appended claims.

1. An injection device for injecting a combined water/gaseous fuel mixture into a combustion space of an engine, the injection device comprising:
a first inlet for receiving a supply of water into a water chamber;
a second inlet for receiving a supply of gaseous fuel into a flow passage;
a mixing device comprising a valve assembly which is configured to control the flow of water between the water chamber and the flow passage so as to establish a combined gaseous fuel/water mixture within the flow passage; and
an injection nozzle including a valve needle which is operable to control the delivery of the combined gaseous fuel/water mixture from the flow passage into the combustion space.

2. The injection device as claimed in claim 1, wherein the injection nozzle is an outwardly-opening injection nozzle in which the valve needle moves outwardly from an injection nozzle housing to initiate delivery of the combined gaseous fuel/water mixture.

3. The injection device as claimed in claim 1, wherein the valve assembly includes an actuator and a shut-off valve member, the actuator being operable to move the shut-off valve member between an open state in which the flow of water is permitted between the water chamber (44) and the flow passage and a closed state in which said flow of water is prevented.

4. The injection device as claimed in claim 1, wherein the valve assembly includes a shut-off valve member which is exposed to gaseous fuel within a gaseous fuel chamber and operable to move, depending on the pressure differential across the shut-off valve member, between an open state in which the flow of water is permitted between the water chamber and the flow passage and a closed state in which said flow of water is prevented.

5. The injection device as claimed in claim 4, wherein the shut-off valve member is operable to open when the valve needle is operated to deliver the combined gaseous fuel/water mixture from the flow passage.

6. The injection device as claimed in claim 4, wherein the valve assembly includes a fuel chamber, and wherein the pressure of fuel within the fuel chamber acts to close the shut-off valve member.

7. The injection device as claimed in claim 6, comprising a venturi device which serves to create a pressure drop in the flow passage to draw fuel out of the fuel chamber.

8. The injection device as claimed in claim 7, further comprising at least one suction port in communication with the fuel chamber which also communicates with the flow passage at a position downstream in a throat region of the venturi device.

9. The injection device as claimed in claim 1, wherein the shut off valve member is an annular member and wherein the fuel passage extends through the shut off valve member.

10. The injection device as claimed in claim 1, wherein the mixing device including a water-metering orifice between the water chamber and the flow passage, whereby the flow of water through the water-metering orifice is under the control of the valve assembly.

11. The injection device as claimed in claim 1, further comprising a damping chamber for damping movement of the shut off valve member.

12. A fuel injection system for injecting gaseous fuel into a combustion space of an engine, the fuel injection system including;
a storage assembly comprising a first store for storing gaseous fuel and a second store for storing water, the first and second stores configured to deliver gaseous fuel and water respectively to the injection device of claim 1.

13. The fuel injection system as claimed in claim 12, wherein the mixing device of the injection device forms a part of the storage assembly.

14. The fuel injection system as claimed in claim 12, wherein the injection nozzle and the mixing device are separated from one another.

15. The fuel injection system as claimed in claim 12, wherein the mixing device is located immediately upstream of the injection device.

16. The fuel injection system as claimed in claim 15, wherein the mixing device is formed in an integrated housing together with the injection device.

17. The fuel injection system as claimed in claim 12, comprising a plurality of injection devices, each having an associated mixing device and configured to deliver a combined water/fuel mixture from an associated flow passage into the combustion space under the control of the injection nozzle.

18. A method of operating an injection device for injecting a combined water/gaseous fuel mixture into a combustion space of an engine, the method comprising:
receiving a supply of water into a water chamber;
receiving a supply of gaseous fuel into a flow passage for fuel;
controlling the flow of water between the water chamber and the flow passage via a shut-off valve member so as to establish a combined gaseous fuel/water mixture within the flow passage; and
operating a valve needle to open so as to inject a combined gaseous fuel/water mixture from the flow passage into the combustion space;
further comprising controlling the shut-off valve member to open the flow of water into the flow passage responsive to the opening of the valve needle.
